(19) United States
(12) Patent Application Publication
(10) Pub. No.: US 2025/0049082 A1
(43) Pub. Date: Feb. 13, 2025

(54) FOOD COMPOSITION

(71) Applicant: Shelly Lynn Bansberg, Hillsboro, OR (US)

(72) Inventor: Shelly Lynn Bansberg, Hillsboro, OR (US)

(21) Appl. No.: 18/799,588

(22) Filed: Aug. 9, 2024

Related U.S. Application Data
(60) Provisional application No. 63/518,486, filed on Aug. 9, 2023.

(51) Int. Cl. A23L 11/00; A23L 13/00; A23L 13/40; A23L 13/60

(52) U.S. Cl. CPC A23L 11/05; A23L 13/06; A23L 13/428; A23L 13/60

(57) ABSTRACT

Example methods, formulations, and/or compositions of matter related to cooked food, cooked food compositions, and mixtures of cooked food compositions are disclosed. In a particular implementation, a cooked food composition may comprise a mixture of a cooked bean composition and a cooked meat composition. In specific aspects, the cooked food composition may have specific concentrations of cooked beans, cooked meat, and a density in a certain range.

### FIELD

The present disclosure relates generally to compositions of matter and, more particularly, to a food composition of cooked beans and cooked meat and methods of its manufacture and use.

### INFORMATION

People have used various cooked food compositions seeking to prepare meals quickly and easily. Still, there remains a need for improved food compositions.

### BRIEF DESCRIPTION OF THE DRAWINGS

The present disclosure may be better understood, and its numerous features and advantages made apparent to those skilled in the art by referencing the accompanying drawings. Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings.

FIG. 1 is a photograph of a cooked food composition, according to an embodiment.

FIG. 2 is a diagram of a process for making a cooked food composition, according to an embodiment.

FIG. 3 is a diagram of a process for making a cooked bean composition, according to an embodiment.

FIG. 4 is a diagram of a process for making a cooked meat composition, according to an embodiment.

FIG. 5 is a diagram of a process for making a cooked meat composition, according to an embodiment.

FIG. 6 is a photograph of tacos made using a cooked food composition, according to an embodiment.

FIG. 7 is a photograph of enchiladas made using a cooked food composition, according to an embodiment.

FIG. 8 is a photograph of a taco bowl made using a cooked food composition, according to an embodiment.

FIG. 9 is a photograph of a quesadilla made using a cooked food composition, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Further, it is to be understood that other embodiments may be utilized. Also, embodiments have been provided of claimed subject matter and it is noted that, as such, those illustrative embodiments are inventive and/or unconventional; however, claimed subject matter is not limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

Present embodiments provide cooked food compositions, methods of their manufacture, and methods of their use. Present embodiments provide various advantages and benefits related to taste of resulting food compositions and/or ease of use over other cooked food compositions. Further, conventional cooked food compositions do not maintain a proper consistency after preparation, freezing, and/or reheating. Moreover, conventional food compositions typically require additional hydration during reheating, which adversely affects taste, texture, and/or mouthfeel.

Embodiments of the present disclosure overcome these problems, and others, providing numerous benefits, by providing a cooked food composition that may be made of all natural ingredients, and be packaged fresh, refrigerated, or frozen, and can be reheated or heated in a microwave or oven. The present embodiments may be used to more quickly and more easily prepare great tasting meals in a relatively short amount of time. They are easily transported for individual lunches in the workplace, family dinners, and/or in bulk for use on airplanes, trains, cruise ships, etc. The present embodiments may also be used in loaded nachos and/or taco salad meals that can be found at sports venues, amusement parks, restaurants, etc. The present embodiments may be packaged in single use and/or family size packaging, such as plastic recyclable containers with a peel off film covering, although any other suitable packaging may be used. The present embodiments may have varying levels of spiciness, such as for example, three levels of spiciness: mild, medium and hot. The present embodiments are versatile in many forms for making flavorful meals, for example by adding to soft flour taco tortilla shells and/or hard corn taco tortilla shells, to make enchiladas and/or burritos, quesadillas, and/or on top of taco salads. The present embodiments may also be easily adapted to replace ground beef and/or to incorporate chicken, pork, shrimp, and/or fish. Notably, embodiments disclosed herein are able to maintain a proper consistency and density that does not involve the addition of any additional water during a thawing or reheating process prior to use. Further, thawed and reheated embodiments are able to maintain acceptable properties of the cooked food composition as when it was initially prepared (e.g., not too runny, has proper consistency, excellent taste, and pleasant mouthfeel).

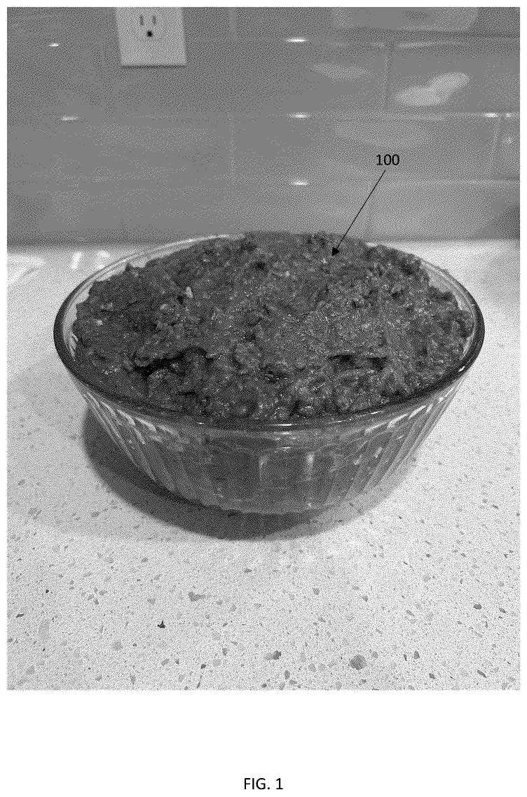

FIG. 1 shows an embodiment of an example food composition 100. Food composition 100 may comprise: a mixture comprising: a cooked bean composition; and a cooked meat composition, wherein the food composition has a density of at least 1.01 g/cm³ and not greater than 1.14 g/cm³, such as at least 1.02 g/cm³ and not greater than 1.13 g/cm³, or at least 1.03 g/cm³ and not greater than 1.12 g/cm³. In an implementation, the density of the cooked food composition may be at least 1.05 g/cm³ and not greater than 1.10 g/cm³, such as at least 1.06 g/cm³ and not greater than 1.09 g/cm³, or at least 1.07 g/cm³ and not greater than 1.08 g/cm³. In another implementation, the density of the cooked food composition may be at least 1.06 g/cm³ and not greater than 1.10 g/cm³, such as at least 1.07 g/cm³ and not greater than 1.09 g/cm³. In one aspect, the cooked bean composition alone may have a density of at least 1.02 g/cm³ and not greater than 1.16 g/cm³, such as at least 1.04 g/cm³ and not greater than 1.14 g/cm³, at least 1.06 g/cm³ and not greater than 1.12 g/cm³, at least 1.07 g/cm³ and not greater than 1.11 g/cm³, or at least 1.08 g/cm³ and not greater than 1.11 g/cm³. In another aspect, the cooked meat composition alone may have a density of at least 1.00 g/cm³ and not greater than 1.12 g/cm³, such as at least 1.01 g/cm³ and not greater than 1.11 g/cm³. In an implementation, the mixture comprises, based on the total weight of the mixture, at least about 30 wt % and not greater than 40 wt % cooked bean composition. In another implementation, the mixture comprises, based on the total weight of the mixture, at least about 55 wt % and not greater than 65 wt % cooked bean composition. In an implementation, the mixture comprises, based on the total weight of the mixture, at least about 60 wt % and not greater than 70 wt % cooked meat composition. In another implementation, the mixture comprises, based on the total weight of the mixture, at least about 35 wt % and not greater than 45 wt % cooked meat composition. In a specific example, the cooked bean composition may comprise: cooked beans; cooked bacon; water; cooked onions; and salt. In another specific example, the cooked meat composition may comprise: cooked meat; tomato sauce; cooked onions; and spices.

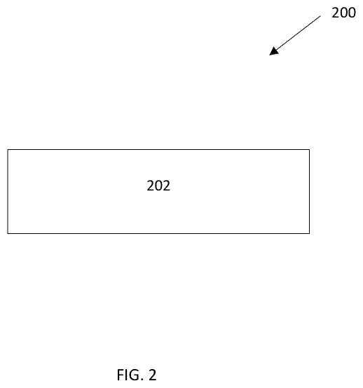

Turning now to FIG. 2, a diagram shows an example embodiment 200 for making a cooked food composition. In an implementation, as referenced generally at 202, a cooked bean composition may be mixed with a cooked meat composition to form the cooked food composition, wherein the cooked food composition has a density of at least 1.01 g/cm³ and not greater than 1.14 g/cm³, such as at least 1.02 g/cm³ and not greater than 1.13 g/cm³, or at least 1.03 g/cm³ to not greater than 1.14 g/cm³.

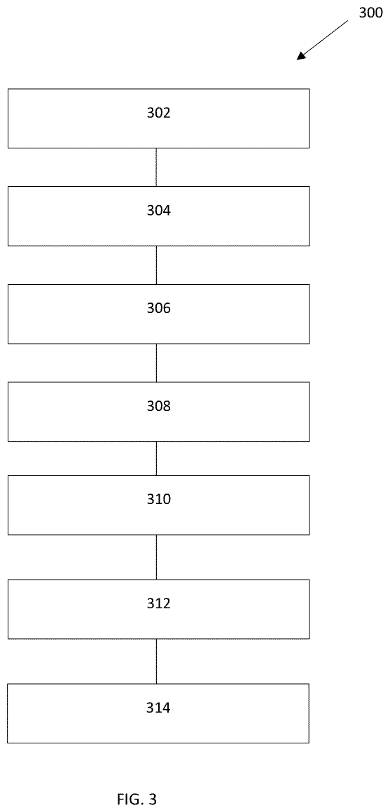

Turning now to FIG. 3, a diagram shows an example process 300 for making a cooked bean composition according to an embodiment. In an implementation, step 302 comprises combining water, salt, and uncooked beans to form a mixture. In step 304, simmering the mixture occurs. Step 306 includes adding onion and water to the mixture. In step 308, simmering the mixture occurs. Step 310 includes adding cooked bacon to the mixture. In step 312, simmering the mixture occurs. Step 314 includes mashing the mixture to form a cooked bean composition. In a specific implementation, simmering the mixture and mashing the mixture may result in the cooked bean composition having a density of at least 1.02 g/cm³ and not greater than 1.16 g/cm³, such as at least 1.04 g/cm³ and not greater than 1.14 g/cm³, at least 1.06 g/cm³ and not greater than 1.12 g/cm³, or at least 1.07 g/cm³ and not greater than 1.11 g/cm³.

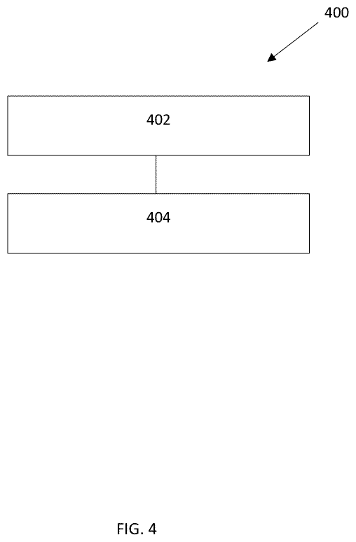

Turning now to FIG. 4, a diagram shows an example process 400 for making a cooked meat composition according to an embodiment. In an embodiment, step 402 comprises combining cooked meat, onions, tomato sauce, hot sauce, spices, and water to form a mixture. In step 404, simmering the mixture occurs to form a cooked meat composition. In a specific implementation, simmering the mixture may result in the cooked meat composition having a density of at least 1.00 g/cm³ and not greater than 1.12 g/cm³, such as at least 1.01 g/cm³ and not greater than 1.11 g/cm³.

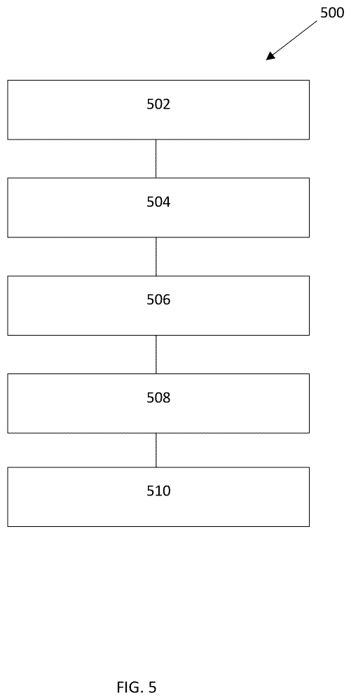

Turning now to FIG. 5, a diagram shows a process 500 for making a cooked meat composition according to an embodiment. In an embodiment, step 502 comprises cooking meat. In a specific implementation, cooking meat includes browning the meat. In step 504, adding onions to the cooked meat to form a mixture occurs. Step 506 includes cooking the mixture. In a specific implementation, cooking the mixture may occur until the onions are soft and translucent. In step 508, adding tomato sauce, hot sauce, and spices to form a mixture occurs. In a specific implementation, spices may include oregano, ground fennel, cumin, garlic, chili powder, and beef bouillon. In a particular example, the beef bouillon may be dissolved in water. Step 510 includes simmering the mixture occurs to form a cooked meat composition. In a specific implementation, simmering the mixture may result in the cooked meat composition having a density of at least 1.00 g/cm³ and not greater than 1.12 g/cm³, such as at least 1.01 g/cm³ and not greater than 1.11 g/cm³.

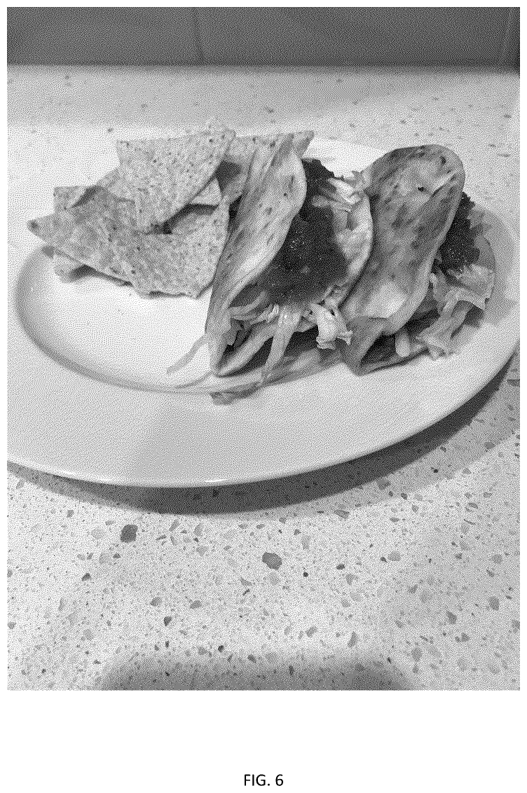

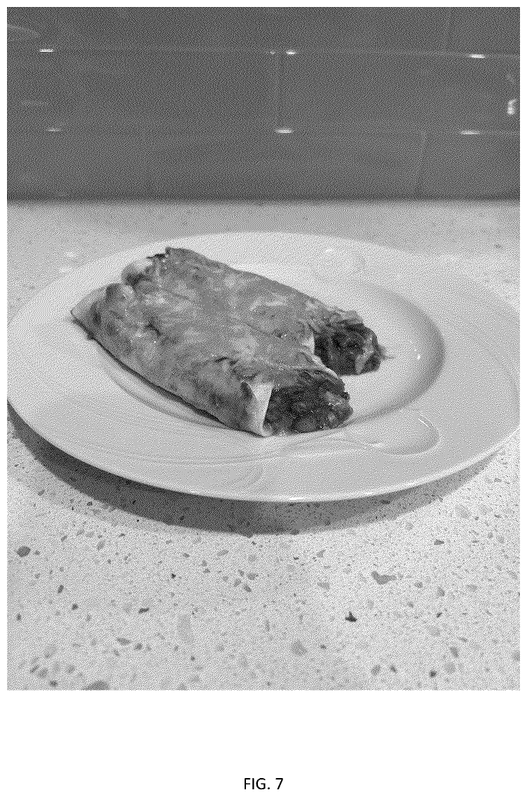

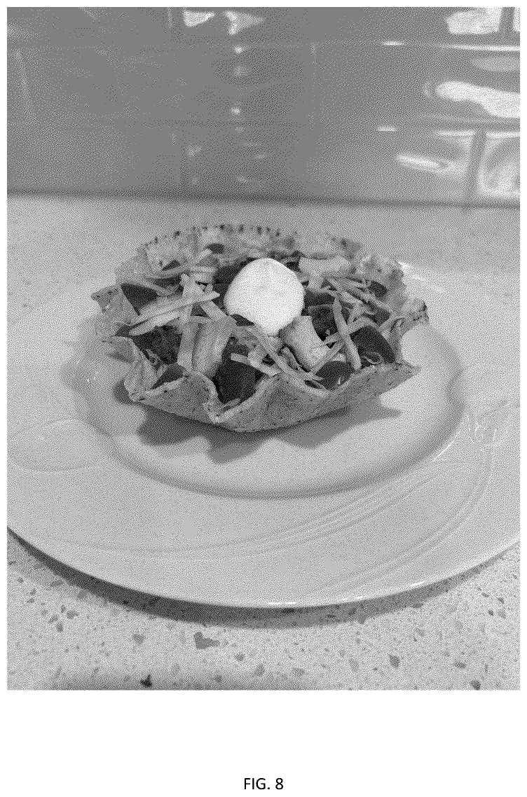

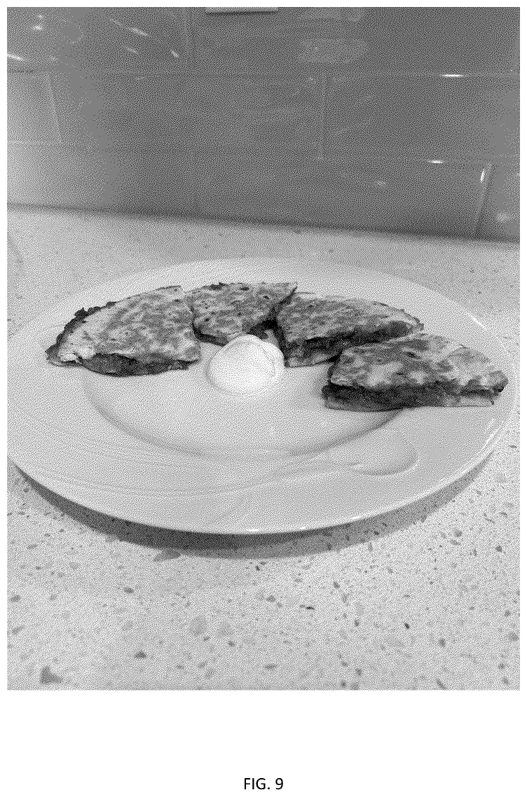

Turning now to FIGS. 6-9, photographs are shown of various Mexican style meals made using a cooked food composition according to an embodiment. FIGS. 6-9 show tacos, enchiladas, a taco bowl, and a quesadilla, respectively, made using a cooked food composition according to an embodiment.

### Cooked Food Composition

A cooked food composition may comprise a mixture of components and ingredients, including other food compositions. In an embodiment, a cooked food composition may comprise a mixture of food compositions. In an implementation, a food composition may comprise: a cooked bean composition; and a cooked meat composition.

### Densities of Compositions

In various implementations of the embodiments described herein, a cooked food composition may comprise a particular density. In a specific embodiment, a cooked food composition may comprise a density of at least 1.01 g/cm³, such as at least 1.02 g/cm³, at least 1.03 g/cm³, at least 1.04 g/cm³, at least 1.05 g/cm³, at least 1.06 g/cm³, or at least 1.07 g/cm³. In a specific embodiment, a cooked food composition may comprise a density of not greater than 1.14 g/cm³, such as not greater than 1.13 g/cm³, not greater than 1.12 g/cm³, not greater than 1.11 g/cm³, not greater than 1.10 g/cm³, not greater than 1.09 g/cm³, not greater than 1.08 g/cm³, or not greater than 1.07 g/cm³. In an implementation, the density of a cooked food composition may have a value in a range of any of the preceding minimum and maximum values. In a specific example, the density of a cooked food composition may comprise a value of at least 1.01 g/cm³ and not greater than 1.14 g/cm³, such as at least 1.02 g/cm³ and not greater than 1.13 g/cm³, at least 1.03 g/cm³ and not greater than 1.12 g/cm³, at least 1.04 g/cm³ and not greater than 1.11 g/cm³, at least 1.05 g/cm³ and not greater than 1.10 g/cm³, or at least 1.06 g/cm³ and not greater than 1.09 g/cm³. In another specific example, the density of a cooked food composition may comprise a value of at least 1.05 g/cm³ and not greater than 1.09 g/cm³.

In various implementations of the embodiments described herein, components of a cooked food composition, including component compositions, mixtures of compositions, or combinations thereof may have a particular density. In a specific embodiment, a cooked food composition may comprise a mixture including a cooked bean composition. In a specific embodiment, a cooked bean composition may comprise a density of at least 1.02 g/cm³, such as at least 1.03 g/cm³, at least 1.04 g/cm³, at least 1.05 g/cm³, at least 1.06 g/cm³, at least 1.07 g/cm³, at least 1.08 g/cm³, at least 1.09 g/cm³, or at least 1.10 g/cm³. In a specific embodiment, a cooked bean composition may comprise a density of not greater than 1.16 g/cm³, such as not greater than 1.15 g/cm³, not greater than 1.14 g/cm³, not greater than 1.13 g/cm³, not greater than 1.12 g/cm³, not greater than 1.11 g/cm³, or not greater than 1.11 g/cm³. In an implementation, the density of a cooked bean composition may have a value in a range of any of the preceding minimum and maximum values. In a specific example, the density of a cooked bean composition may comprise a value of at least 1.02 g/cm³ and not greater than 1.16 g/cm³, such as at least 1.03 g/cm³ and not greater than 1.14 g/cm³, at least 1.04 g/cm³ and not greater than 1.12 g/cm³, or at least 1.05 g/cm³ and not greater than 1.11 g/cm³, or at least 1.06 g/cm³ and not greater than 1.10 g/cm³. In another specific example, the density of a cooked bean composition may comprise a value of at least 1.05 g/cm³ and not greater than 1.08 g/cm³.

In a specific embodiment, a cooked food composition may comprise a mixture including a cooked meat composition. In a specific embodiment, a cooked meat composition may comprise a density of at least 1.00 g/cm³, such as 1.01 g/cm³, at least 1.01 g/cm³, at least 1.02 g/cm³, at least 1.03 g/cm³, at least 1.04 g/cm³, or at least 1.05 g/cm³. In a specific embodiment, a cooked meat composition may comprise a density of not greater than 1.12 g/cm³, such as not greater than 1.11 g/cm³, not greater than 1.10 g/cm³, not greater than 1.09 g/cm³, not greater than 1.08 g/cm³, or not greater than 1.07 g/cm³. In an implementation, the density of a cooked meat composition may have a value in a range of any of the preceding minimum and maximum values. In a specific example, the density of a cooked meat composition may comprise a value of at least 1.00 g/cm³ and not greater than 1.12 g/cm³, such as at least 1.01 g/cm³ and not greater than 1.11 g/cm³, at least 1.02 g/cm³ and not greater than 1.10 g/cm³, at least 1.03 g/cm³ and not greater than 1.09 g/cm³, at least 1.04 g/cm³ and not greater than 1.08 g/cm³, or at least 1.05 g/cm³ and not greater than 1.07 g/cm³. In another specific example, the density of a cooked meat composition may comprise a value of at least 1.05 g/cm³ and not greater than 1.09 g/cm³.

### Concentration of Cooked Bean Composition

In various implementations of the embodiments described herein, a cooked food composition may comprise a mixture having a varying amount of a cooked bean composition. In a specific embodiment, based on the total weight of the mixture, a mixture may comprise at least about 30 wt % of cooked bean composition, such as at least 31 wt %, at least 32 wt %, at least 33 wt %, at least 34 wt %, or at least 35 wt % of cooked bean composition. In a specific embodiment, based on the total weight of the mixture, a mixture may comprise not greater than about 40 wt % cooked bean composition, such not greater than 39 wt %, not greater than 38 wt %, not greater than 37 wt %, or not greater than 36 wt % cooked bean composition. In an implementation, the amount of cooked bean composition may have a value in a range of any of the preceding minimum and maximum values. In a specific example, the amount of a cooked bean composition may comprise a value of at least about 30 wt % and not greater than 40 wt %, such as at least about 31 wt % and not greater than 39 wt %, at least about 32 wt % and not greater than 38 wt %, at least about 33 wt % and not greater than 37 wt %, or at least about 34 wt % and not greater than 36 wt % cooked bean composition. In another specific embodiment, based on the total weight of the mixture, a mixture may comprise at least about 55 wt % of cooked bean composition, such as at least 56 wt %, at least 57 wt %, at least 58 wt %, at least 59 wt %, or at least 60 wt % of cooked bean composition. In a specific embodiment, based on the total weight of the mixture, a mixture may comprise not greater than about 65 wt % cooked bean composition, such not greater than 64 wt %, not greater than 63 wt %, not greater than 62 wt %, or not greater than 61 wt % cooked bean composition. In an implementation, the amount of cooked bean composition may have a value in a range of any of the preceding minimum and maximum values. In a specific example, the amount of a cooked bean composition may comprise a value of at least about 55 wt % and not greater than 65 wt %, such as at least about 56 wt % and not greater than 64 wt %, at least about 57 wt % and not greater than 63 wt %, or at least about 58 wt % and not greater than 62 wt % cooked bean composition.

### Concentration of Cooked Meat Composition

In various implementations of the embodiments described herein, a cooked food composition may comprise a mixture having a varying amount of a cooked meat composition. In a specific embodiment, based on the total weight of the mixture, a mixture may comprise at least about 60 wt % of cooked meat composition, such as at least 61 wt %, at least 62 wt %, at least 63 wt %, or at least 64 wt % of cooked meat composition. In a specific embodiment, based on the total weight of the mixture, a mixture may comprise not greater than about 70 wt % cooked meat composition, such not greater than 69 wt %, not greater than 68 wt %, not greater than 67 wt %, or not greater than 66 wt % cooked meat composition. In an implementation, the amount of cooked meat composition may have a value in a range of any of the preceding minimum and maximum values. In a specific example, the amount of a cooked meat composition may comprise a value of at least about 60 wt % and not greater than 70 wt %, such as at least about 61 wt % and not greater than 69 wt %, at least about 62 wt % and not greater than 68 wt %, at least about 63 wt % and not greater than 67 wt %, or at least about 64 wt % and not greater than 66 wt % cooked meat composition. In another specific embodiment, based on the total weight of the mixture, a mixture may comprise at least about 35 wt % of cooked meat composition, such as at least 36 wt %, at least 37 wt %, at least 38 wt %, at least 39 wt %, or at least 40 wt % of cooked meat composition. In a specific embodiment, based on the total weight of the mixture, a mixture may comprise not greater than about 45 wt % cooked meat composition, such not greater than 44 wt %, not greater than 43 wt %, not greater than 42 wt %, or not greater than 41 wt % cooked meat composition. In an implementation, the amount of cooked meat composition may have a value in a range of any of the preceding minimum and maximum values. In a specific example, the amount of a cooked meat composition may comprise a value of at least about 35 wt % and not greater than 45 wt %, such as at least about 36 wt % and not greater than 44 wt %, at least about 37 wt % and not greater than 43 wt %, or at least about 38 wt % and not greater than 42 wt % cooked meat composition.

### Cooked Bean Composition (Components and Wt %)

In various implementations of the embodiments described herein, a cooked bean composition may comprise cooked beans, cooked bacon, cooked onions, salt, water, or a combination thereof. In a specific implementation, a cooked bean composition may comprise cooked beans, cooked bacon, cooked onions, salt, and water. The amounts of cooked beans, cooked bacon, cooked onions, salt, and water in a cooked bean composition can vary. In a particular implementation, a cooked bean composition may comprise, based on the total weight of the cooked bean composition:

| | |
|---|---|
| 56 wt % to 68 wt % | cooked beans; |
| 18 wt % to 28 wt % | cooked bacon; |
| 3 wt % to 12 wt % | water; |
| 2 wt % to 8 wt % | cooked onions; and |
| 0.25 wt % to 1 wt % | salt. |

Suitable beans include pinto beans, black beans, or combinations thereof. Suitable bacon includes streaky bacon, also known as American bacon or side bacon, back bacon, collar bacon, jowls, lardons, pancetta, speck, smoked bacon, flavored bacon, turkey bacon, duck bacon, salmon bacon, dulse, or a combination thereof. Suitable onions include yellow onions, white onions, purple onions, or a combination thereof. Suitable salt includes table salt, kosher salt, sea salt, black salt, pink salt, or a combination thereof. Suitable water is a potable water, including tap water, spring water, or a combination thereof.

### Cooked Meat Composition (Components and Wt %)

In various implementations of the embodiments described herein, a cooked meat composition may comprise cooked meat, tomato sauce, cooked onions, spices, water, or a combination thereof. In a specific implementation, a cooked meat composition may comprise cooked meat, tomato sauce, cooked onions, and spices. The amounts of cooked meat, tomato sauce, cooked onions, spices, and water in a cooked meat composition can vary. In a particular implementation, a cooked meat composition may comprise, based on the total weight of the cooked meat composition:
47 wt % to 68 wt % cooked meat;
25 wt % to 35 wt % tomato sauce;
2 wt % to 6 wt % cooked onions; and
0.25 wt % to 3 wt % spices.

Suitable meat includes beef, pork, chicken, turkey, duck, fish, shrimp, or a combination thereof. The meat may be sliced, chopped, shredded, ground, or a combination thereof. In a particular implementation, the meat comprises ground beef. Suitable tomato sauce includes plain tomato sauce, flavored tomato sauce, or a combination thereof. Suitable onions include yellow onions, white onions, purple onions, or a combination thereof.

As used herein, “spices” comprises oregano, fennel, cumin, garlic, chili powder, beef bouillon, a mixture thereof, or a combination thereof. The spices may be chopped, crushed, ground, pressed, or a combination thereof. The spices may be cooked, raw, or a combination thereof. In a particular implementation, a cooked meat composition may comprise, based on the total weight of the cooked meat composition:
0.1 wt % to 0.25 wt % oregano;
0.1 wt % to 0.25 wt % ground fennel;
0.1 wt % to 0.25 wt % cumin;
0.1 wt % to 0.25 wt % pressed garlic;
0.1 wt % to 1.0 wt % hot sauce;
0.1 wt % to 1.0 wt % chili powder; and
0.05 wt % to 0.2 wt % beef bouillon.

### Example 1—Cooked Food Composition

A cooked bean composition and a cooked meat composition were prepared and combined by mixing together to form a cooked food composition as described herein.

1a. Bean Composition

A bean composition was prepared as described herein.

| Bean mixture, uncooked: | weight (g) | weight (%) |
|---|---|---|
| pinto beans - rinsed, 1 pound | 454 | 21.77% |
| water - 5 cups | 1183 | 56.74% |
| salt - ½ teaspoon | 3 | 0.14% |
| onion - diced, ¾ cup | 39 | 1.87% |
| water - 1 cup | 237 | 11.37% |
| bacon - cooked, diced fine, ¾ cup | 169 | 8.11% |
| | 2085 | 100.0% |

One pound of rinsed uncooked pinto beans was placed in a large saucepan. Five cups of water and a half teaspoon of salt were added to the beans and water. The saucepan was covered and cooked at a simmer on low heat for one hour. A ¾ cup of diced onion and an additional one cup of water were added to the mixture and simmered for one more hour. A ¾ cup of finely diced cooked bacon was added to the mixture and simmered for another hour. Three hours was the total time for cooking the bean mixture. The cooked bean mixture was placed in large glass mixing bowl and mashed with a potato masher until most chunks were no longer visible. The completed cooked bean composition was ready for use or could be placed in a refrigerator or freezer for storage. Samples of cooked bean composition were prepared as described above and had densities ranging from 1.02 g/cm³ to 1.11 g/cm³.

1b. Meat Composition

A cooked meat composition was prepared as described herein.

| Meat mixture: | weight (g) | weight (%) |
|---|---|---|
| 2 pounds ground beef | 908 | 47.02% |
| 1 c onions - finely minced - | 52 | 2.69% |
| 1 t oregano - | 2 | 0.10% |
| 1 t ground fennel - | 2 | 0.10% |
| 1 t cumin - | 2 | 0.10% |
| 1 ½ t garlic - 2 cloves pressed - | 3 | 0.16% |
| 2 t hot sauce - | 10 | 0.52% |
| 3 t chili powder - | 6 | 0.31% |
| 16 oz tomato sauce - | 473 | 24.50% |
| 2 c water / 3 beef bouillon dissolved - | 473 | 24.50% |
| | 1931 | 100.00% |

Ground beef was browned in large deep skillet. Substantially all grease was drained from the browned meat. Onions were added to the meat and the mixture was cooked until the onions were soft and translucent. The remaining ingredients: oregano, fennel, cumin, garlic, hot sauce, chili powder, tomato sauce, and beef bouillon dissolved in water were added to the mixture. The mixture was simmered on low heat for one hour while uncovered until the mixture was no longer a soupy consistency. The cooked mixture was allowed to sit at room temperature to cool and was then ready to be mixed with the cooked bean composition produced above in example 1a. Samples of cooked meat composition were prepared as described above and had densities ranging from 1.00 g/cm³ to 1.11 g/cm³.

1c. Bean and Meat Composition

A sample cooked food composition comprising a mixture of the cooked bean composition from 1a and the cooked meat composition from 1b was prepared as described herein. The cooked food composition was made by mixing together the components listed in the table below.

| | | | wt % of | vol % of | |
|---|---|---|---|---|---|
| | weight | Volume | Final | Final | density |
| | (g) | (cm³) | Mixture | Mixture | (g/cm³) |
| Cooked Bean | 724 | 650.62 | 35.35% | 34.4% | 1.11 |
| Composition | | | | | |
| Cooked Meat | 1324 | 1242.09 | 64.65% | 65.6% | 1.07 |
| Composition | | | | | |
| Final Mixture | 2048 | 1892.71 | 100.00% | 100.00% | 1.08 |

The recipe produced a sample cooked food composition having a total volume of 8 cups and a total weight of 2,048 grams. A 2-cup serving weighed 512 grams. The sample cooked food composition was moist, well flavored, and had a pleasant mouth feel. Surprisingly and beneficially, the cooked food composition having a suitable density, was not soupy or runny, and could be placed in a soft tortilla easily but without concern that the cooked food composition would run out of the tortilla while being held or while being eaten.

Another sample cooked food composition was prepared comprising a mixture of a cooked bean composition prepared as described above according to 1a and a cooked meat composition prepared as described above according to 1b. The cooked food composition was made by mixing together the components listed in the table below.

| | | | wt % of | vol % of | |
|---|---|---|---|---|---|
| | weight | Volume | Final | Final | density |
| | (g) | (cm³) | Mixture | Mixture | (g/cm³) |
| Cooked Bean | 1542 | 1460.47 | 61.73% | 61.73% | 1.06 |
| Composition | | | | | |
| Cooked Meat | 956 | 905.43 | 38.27% | 38.27% | 1.06 |
| Composition | | | | | |
| Final Mixture - | 2498 | 2365.90 | 100.00% | 100.00% | 1.06 |
| Cooked Food | | | | | |
| Composition | | | | | |

The recipe produced a sample cooked food composition having a total volume of 10 cups and a total weight of 2,498 grams. A 2-cup serving weighed 500 grams. The sample cooked food composition was moist, well flavored, and had a pleasant mouth feel. Surprisingly and beneficially, the cooked food composition having a suitable density, was not soupy or runny, and could be placed in a soft tortilla easily but without concern that the cooked food composition would run out of the tortilla while being held or while being eaten.

### Example 2—Thawing and Heating Bean and Meat Composition

A sample of the cooked food composition was prepared as above in Example 1 and was then frozen and stored in a freezer for multiple days. The frozen sample of cooked food composition was removed from the freezer and thawed in a refrigerator one day prior to planned consumption. The sample was then heated in a microwave, for a one cup serving, on high for 45 seconds. The sample was then removed and stirred, and heated for an additional 45 seconds. Notably, the sample maintained the proper consistency, density, and did not require the addition of any water during the thawing and reheating process prior to use. The thawed and reheated sample maintained the acceptable properties of the cooked food composition as when it was initially prepared (e.g., not too runny, had proper consistency, and still had desired taste and mouthfeel).

### Example 3—Sample Prepared Meals

The thawed and reheated sample from Example 2 was used to more easily and more quickly prepare tacos, enchiladas, a taco bowl, and a quesadilla as shown in FIGS. 6-9, respectively.

The description in combination with the figures is provided to assist in understanding the teachings disclosed herein. The discussion focuses on specific implementations and embodiments of the teachings. This focus is provided to assist in describing the teachings and should not be interpreted as a limitation on the scope and/or applicability of the teachings. However, other embodiments can be used, in whole or in part, based on the teachings as disclosed in this application.

The terms “comprises,” “comprising,” “includes,” “including,” “has,” “having” or any other variation thereof, are intended to be a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive meaning of “or” and not to an exclusive meaning of “or.” For example, a condition A or B is satisfied by any one of the following: A is true (or present), and B is false (or not present), A is false (or not present), and B is true (or present), and both A and B are true (or present).

Also, the use of the terms “a” or “an” is employed to describe elements and components herein. This is done merely for convenience and to give a general sense of the scope of the embodiments. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

As used herein, the terms “generally equal,” “generally same,” “substantially,” and the like, refer to deviations of no greater than 10% of a chosen value. For more than two values, the deviation can be measured with respect to a central value. For example, “generally equal” refers to two or more conditions that are no greater than 10% different in value. Demonstratively, angles offset from one another by 98% are generally perpendicular.

Unless otherwise defined, technical and scientific terms used herein have the same meaning as commonly understood by one of ordinary skill in the art to which these embodiments belong. The materials, methods, and examples are illustrative only and not intended to be limiting. To the extent not described herein, many details regarding specific materials and processing acts are conventional and may be found in textbooks and other sources within the wild game calling arts.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges include each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A cooked food composition comprising:
a mixture comprising:
a cooked bean composition; and
a cooked meat composition,
wherein the cooked food composition has a density of at least 1.01 g/cm³ and not greater than 1.14 g/cm³.

2. The cooked food composition of claim 1, wherein the cooked bean composition has a density of at least 1.02 g/cm³ and not greater than 1.16 g/cm³.

3. The cooked food composition of claim 1, wherein the cooked meat composition has a density of at least 1.00 g/cm³ and not greater than 1.12 g/cm³.

4. The cooked food composition of claim 1, wherein the mixture comprises, based on the total weight of the mixture, at least about 55 wt % cooked bean composition.

5. The cooked food composition of claim 4, wherein the mixture comprises, based on the total weight of the mixture, not greater than about 65 wt % cooked bean composition.

6. The cooked food composition of claim 1, wherein the mixture comprises, based on the total weight of the mixture, at least about 35 wt % cooked meat composition.

7. The cooked food composition of claim 6, wherein the mixture comprises, based on the total weight of the mixture, not greater than about 45 wt % cooked meat composition.

8. The cooked food composition of claim 1, wherein the cooked bean composition comprises: cooked beans; cooked bacon; water; cooked onions; and salt.

9. The cooked food composition of claim 8, wherein the cooked bean composition comprises, based on the total weight of the cooked bean composition:
56 wt % to 68 wt % cooked beans;
18 wt % to 28 wt % cooked bacon;
3 wt % to 12 wt % water;
2 wt % to 8 wt % cooked onions; and
0.25 wt % to 1 wt % salt.

10. The cooked food composition of claim 1, wherein the cooked meat composition comprises: cooked meat; tomato sauce; cooked onions; and spices.

11. The cooked food composition of claim 10, wherein the cooked meat composition comprises, based on the total weight of the cooked meat composition:
57 wt % to 68 wt % cooked meat;
25 wt % to 35 wt % tomato sauce;
2 wt % to 6 wt % cooked onions; and
0.25 wt % to 3 wt % spices.

12. The cooked food composition of claim 11, wherein the spices comprise, based on the total weight of the cooked meat composition:
0.1 wt % to 0.25 wt % oregano;
0.1 wt % to 0.25 wt % ground fennel;
0.1 wt % to 0.25 wt % cumin;
0.1 wt % to 0.25 wt % pressed garlic;
0.1 wt % to 1.0 wt % hot sauce;
0.1 wt % to 1.0 wt % chili powder; and
0.05 wt % to 0.2 wt % beef bouillon.

13. A cooked food composition made by a process comprising:
mixing a cooked bean composition with a cooked meat composition to form the cooked food composition,
wherein the cooked food composition has a density of at least 1.01 g/cm³ to not greater than 1.14 g/cm³.

14. The cooked food composition of claim 13, wherein the cooked bean composition is made by a process comprising:
combining water, salt, and uncooked beans to form a mixture;
simmering the mixture;
adding onion and water to the mixture;
simmering the mixture;
adding cooked bacon to the mixture;
simmering the mixture; and
mashing the mixture to form the cooked bean composition.

15. The cooked food composition of claim 14, wherein the cooked bean composition has a density of at least 1.02 g/cm³ and not greater than 1.16 g/cm³.

16. The cooked food composition of claim 13, wherein the cooked bean composition is made by a process comprising:
combining the below listed ingredients, based on the total weight of the listed ingredients, to form a mixture:
15 wt % to 25 wt % uncooked beans;
3 wt % to 13 wt % cooked bacon;
1 wt % to 3 wt % uncooked onions;
0.05 wt % to 0.25 wt % salt; and
63 wt % to 73 wt % water;
simmering the mixture; and
mashing the mixture to form a cooked bean composition.

17. The cooked food composition of claim 13, wherein the cooked meat composition is made by a process comprising:
cooking meat,
adding onions to the cooked meat to form a mixture;
cooking the mixture;
adding tomato sauce, hot sauce, and spices to form a mixture; and
simmering the mixture to form the cooked meat composition.

18. The cooked food composition of claim 17, wherein simmering the mixture results in the cooked meat composition having a density of at least 1.00 g/cm³ and not greater than 1.12 g/cm³.

19. The cooked food composition of claim 13, wherein the cooked meat composition is made by a process comprising:
combining the below listed ingredients, based on the total weight of the listed ingredients, to form a mixture:
40 wt % to 50 wt % uncooked meat;
20 wt % to 30 wt % tomato sauce;
1 wt % to 4 wt % uncooked onions;
01 wt % to 3 wt % spices; and
20 wt % to 30 wt % water; and
simmering the mixture to form a cooked meat composition.

20. A method of making a cooked food composition comprising:
making a cooked bean composition by a process comprising:
combining water, salt, and uncooked beans to form a first mixture;
simmering the first mixture;
adding onion and water to the first mixture;
simmering the first mixture;
adding cooked bacon to the first mixture;
simmering the first mixture;
mashing the first mixture to form a cooked bean composition,
wherein the cooked bean composition has a density of at least 1.02 g/cm³ and not greater than 1.16 g/cm³;
making a cooked meat composition by a process comprising:
cooking meat,
adding onions to cooked meat to form a second mixture;
cooking the second mixture;
adding tomato sauce, hot sauce, and spices, and water to the second mixture;
simmering the second mixture to form a cooked meat composition,
wherein the cooked meat composition alone (prior to mixing) has a density of at least 1.00 g/cm³ and not greater than 1.12 g/cm³; and
mixing the cooked bean composition with the cooked meat composition to form the cooked food composition,
wherein the cooked food composition has a density of at least 1.01 g/cm³ to not greater than 1.14 g/cm³.
